(19) United States
(12) Patent Application Publication
(10) Pub. No.: US 2014/0007820 A1
(43) Pub. Date: Jan. 9, 2014

(54) Cat Spray Blocker and Catcher

(71) Applicant: Fay A. Lenz, Boise, ID (US)

(72) Inventor: Fay A. Lenz, Boise, ID (US)

(21) Appl. No.: 13/722,693

(22) Filed: Dec. 20, 2012

Related U.S. Application Data
(60) Provisional application No. 61/577,798, filed on Dec. 20, 2011.

(51) Int. Cl. A01K 23/00

(52) U.S. Cl. CPC A01K 23/00
USPC 119/869

(57) ABSTRACT

The present disclosed technology is a pet care product which blocks and catches cat spray, preventing the spray from being spread around in the pet owner's home on walls, furniture and carpets. The blocker and catcher is a preferably waterproof panel positioned beneath the cat's tail and closely behind the cat's butt. Preferably, the waterproof panel is positioned by hanging from a tail cord or strap which passes around the cat's tail. Preferably, the tail cord or strap is itself connected to the top side of a waist strap which passes around the cat's waist. This way, the waterproof panel hangs down behind the butt of the cat which is the area of the cat spray, and the panel blocks, deflects, catches and even collects the cat spray when it occurs.

### BACKGROUND OF THE DISCLOSED TECHNOLOGY

1. Field of the Disclosed Technology

This disclosed technology relates generally to accessories for pets, especially cats. More specifically, this disclosed technology relates to a cat spray blocker and catcher accessory worn by cats to protect homes and furnishings from cat spray.

2. Related Art

There are many products provided to clean up, freshen and sanitize the spray from cats in households.

Also, there are several products for catching urine, feces, etc. from pets in pet diapers. However, these pet diapers typically require frequent changing, which may be unpleasant and time consuming. Also, while worn, typically these pet diaper products prevent normal pet activity like urinating, defecating and sex. Examples of these pet diapers are disclosed in U.S. Pat. Nos. 6,142,105 (McNight) and 7,753,008 (Krenkel), and in published US Patent Application number 2005/0263105 (Moharram).

Still, there is a need for an economic and effective cat spray blocker and catcher accessory which may be conveniently worn by cats without interfering with normal bodily functions. This disclosed technology addresses that need.

### SUMMARY OF THE DISCLOSED TECHNOLOGY

The present disclosed technology is a pet care product which blocks and catches cat spray, preventing the spray from being spread around in the pet owner's home on walls, furniture and carpets, for example, and negatively affecting the household. The instant cat spray blocker and catcher is an accessory worn for extended time periods by the cat. The blocker is a preferably waterproof panel positioned beneath the cat's tail and closely behind the cat's butt. Preferably, the waterproof panel is positioned by hanging from a tail cord or strap which passes around or by both sides of the cat's tail. Preferably, the tail cord or strap is itself connected to a strap which passes around the cat's waist.

Preferably, the tail cord or strap for positioning the waterproof panel is connected to the top side of the waist belt on the cat. Preferably, the distance rearwardly of the tail cord or strap from the waist belt is adjustable. Also preferably, the elevation difference for the waterproof panel beneath the cat's tail is adjustable. This way, the waterproof panel hangs down behind the butt of the cat which is the area of the cat spray, and the panel blocks, deflects and catches the cat spray when it occurs.

In addition, preferably there is a pocket at or near the bottom of the waterproof panel on the inside of the panel toward the cat's butt. The pocket is on the inside surface (closest to the cat's butt) of the panel, open to the top, and closed to the bottom. Preferably, there is also a removable, disposable absorbent pad in the pocket. This way, when the waterproof panel has blocked and deflected the cat spray, the spray residue drains down the panel into the pocket, to be absorbed therein by the preferably removable, disposable absorbent pad. Also, this way the absorbed cat spray in the pocket may be easily removed by removing the absorbent pad for disposal.

Many of the dimensions and the shape of the waterproof panel may be effectively adjusted. Basically, the panel is adjustable, like part of a garment, to fit the cat. Likewise different, appropriate materials and structures of different shapes and sizes may be used to make the waist belt, tail cord, waterproof panel, pocket and absorbent material in the pocket.

### BRIEF DESCRIPTION OF THE DRAWINGS

FIG. 1 is a back perspective view of one embodiment of the cat spray blocker and catcher of the present disclosed technology, including a connecting tail cord to a waist belt, on a cat.

FIG. 2 is a rear view of the embodiment of the presently disclosed technology depicted in FIG. 1.

FIG. 3 is a top perspective view of the embodiment depicted in FIGS. 1 and 2.

FIG. 4 is a rear perspective view of the spray blocker and catcher depicted in FIGS. 1-3, but without the cat.

FIG. 5 is a side perspective view of the embodiment depicted in FIG. 4.

FIG. 6 is a front perspective exploded view of the embodiment depicted in FIGS. 1-5.

FIG. 7 is a front perspective detail view of the instant blocker and catcher with the tail cord but without the waist belt.

FIG. 8 is a top detail view of the blocker and catcher but with only two fragments of the tail cord.

FIG. 9 is a front view of FIG. 8.

FIG. 10 is a side view of FIG. 9

FIG. 11 is a view like FIG. 4, but of a different embodiment of the disclosed technology with a different fastener for securing the tail cord to the waist belt.

FIG. 12 is a side view of the embodiment depicted in FIG. 11.

### DETAILED DESCRIPTION OF SEVERAL EMBODIMENTS OF THE DISCLOSED TECHNOLOGY

Referring to the Figures, there are shown several, but not all, embodiments of the disclosed technology.

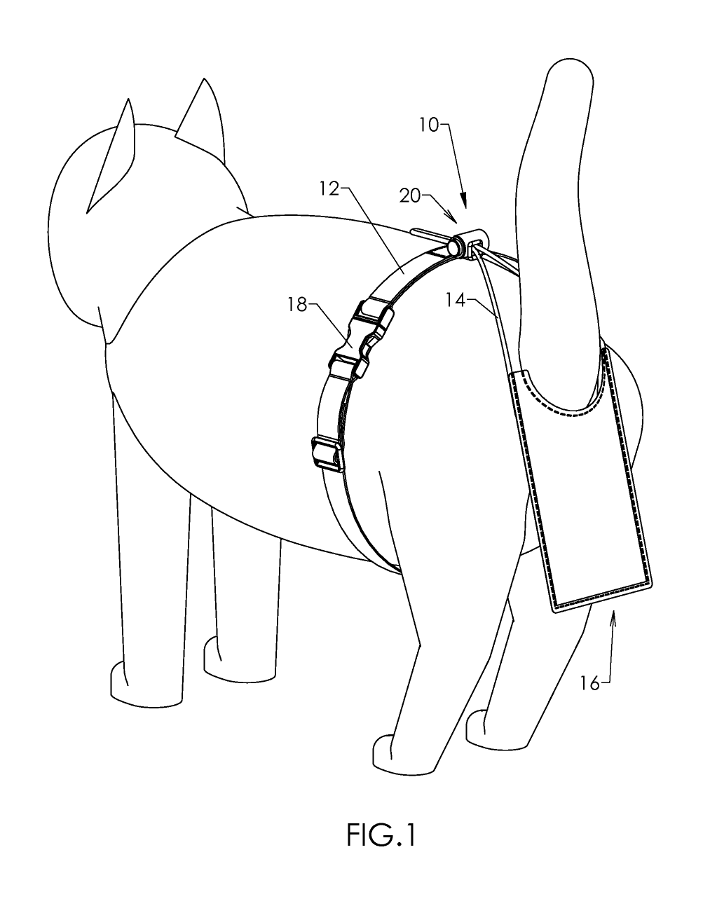

FIG. 1 depicts one embodiment 10 of the cat spray blocker/catcher on a cat. Blocker/catcher 10 has a waist belt 12, tail cord 14 and block/catch panel 16. Preferably, waist belt 12 is adjustable to fit comfortably on different sized cats, or to adjust to the growth of a single cat. In this embodiment, waist belt 12 also has convenient belt clip 18.

Tail cord 14 attaches to waist belt 12, preferably near the middle of the cat's back above its hips. This way, tail cord 14 at waist belt 12 is centered along the top back of the cat's body. In this embodiment, the tail cord 14 is a loop which extends around or by both sides of the cat's tail, beginning and ending near adjustable tail cord clamp 20 which is connected to waist belt 12. Tail cord 14 extends into or onto, and is secured to, the lateral edges of block/catch panel 16. In one embodiment, tail cord 14 extends entirely around the left side edge (looking from the rear of the cat), bottom and right side edge of block/catch panel 16, providing added strength and integrity to the sub-assembly of the tail cord and block/catch panel 16. This way, due to the adjustability in the length of tail cord 14 through tail cord clamp 20, the elevation of block/catch panel 16 may be conveniently adjusted to comfortably, yet effectively, fit the cat.

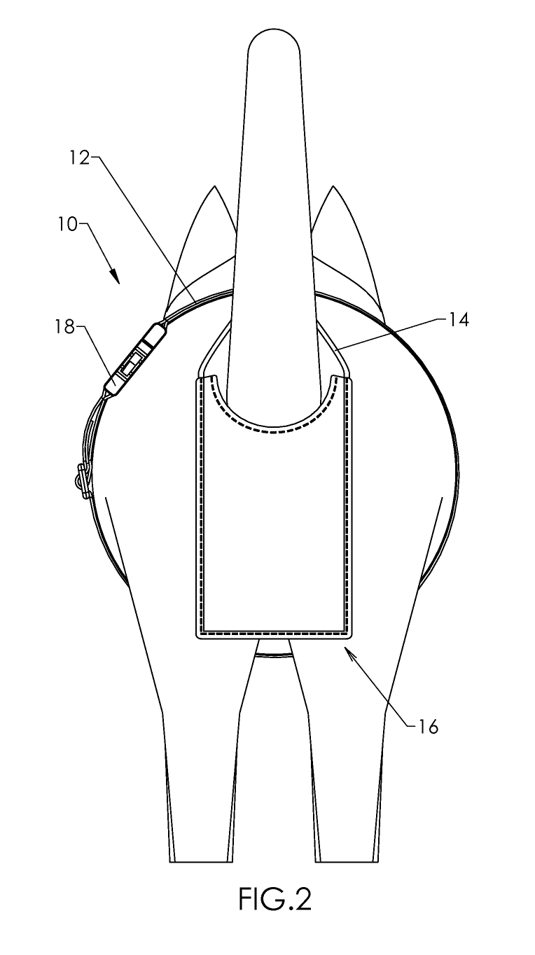

FIG. 2 is a rear view of the embodiment depicted in FIG. 1. FIG. 2 shows that the symmetry of tail cord 14 being connected to waist belt 12 at the top of the cat's back above the hips provides a good fit of block/catch panel 16 just beneath the tail of the cat. In an alternative embodiment, tail cord 14 may attach to the center top of a chest harness (not shown), for example, instead of waist belt 12. Or, tail cord 14 may attach to the center top of a neck collar (not shown), for example, instead of waist belt 12. In either or both of these alternative embodiments, tail cord 14 will extend further up the cat's back, and it may be a single cord nearer the front of the cat, with a loop around or by both sides of the cat's tail. Or, in either or both of these alternative embodiments, tail cord 14 may be a double cord, with clip or other structure near the cat's tail to permit the cords to pass by both sides of the cat's tail.

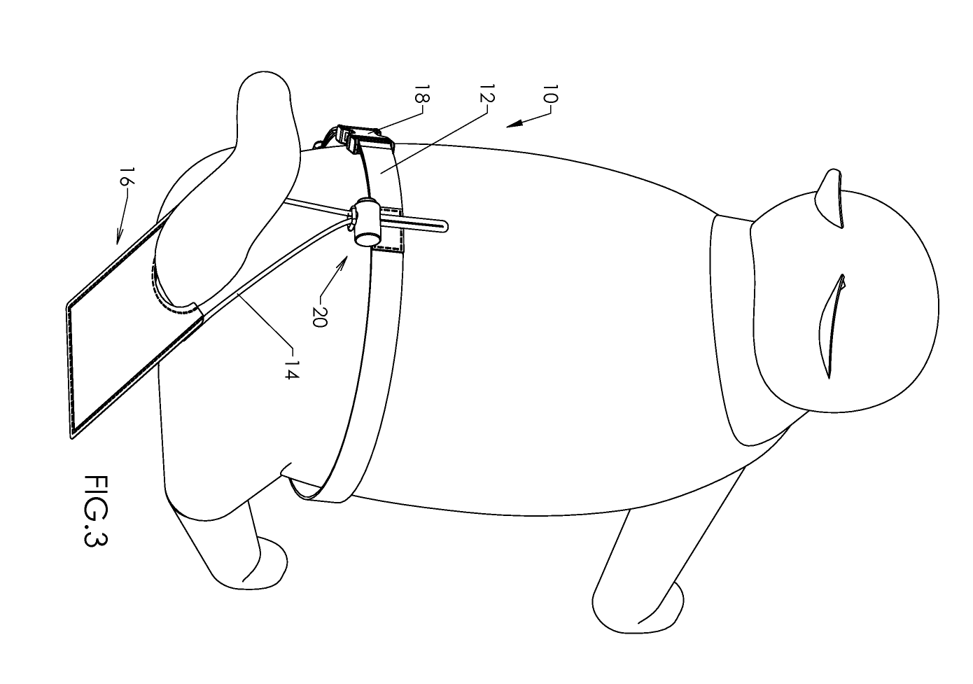

FIG. 3 is a top perspective view of the embodiment depicted in FIGS. 1 and 2.

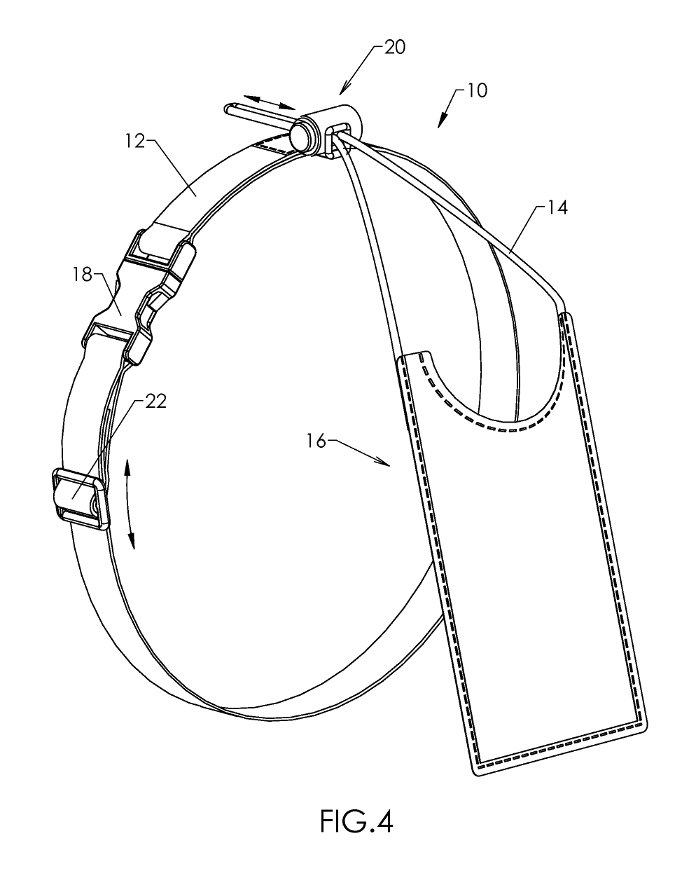

FIG. 4 is a rear perspective view of the spray blocker/catcher embodiment 10 depicted in FIGS. 1-3, but without the cat. The bi-directional arrows in this Figure indicate the adjustability in the length of tail cord 14 through tail cord clamp 20, and of waist belt 12 through loop and buckle assembly 22.

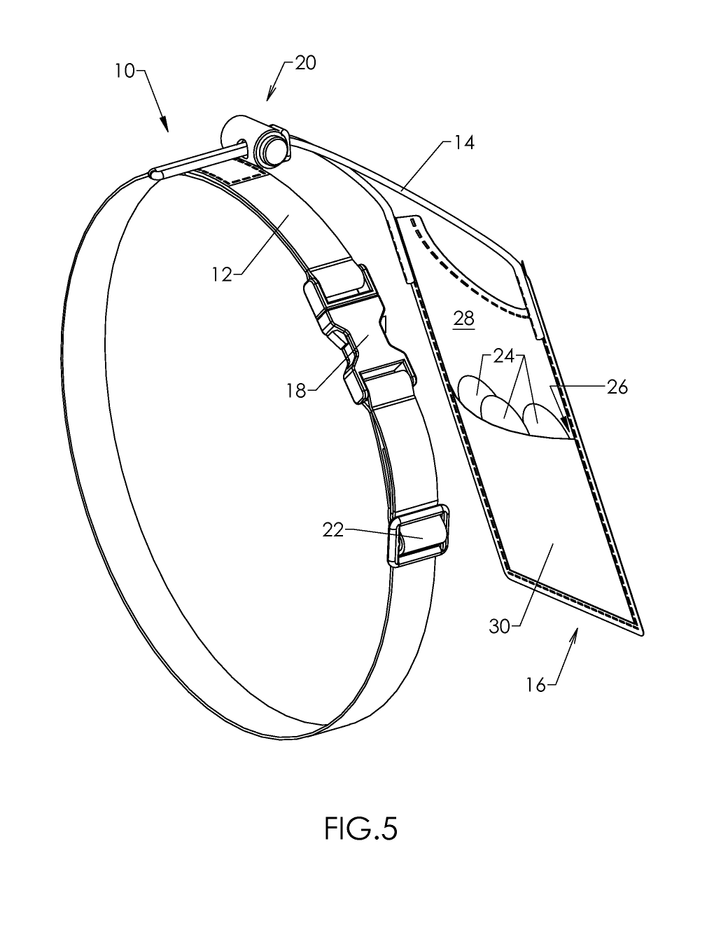

FIG. 5 is a side perspective view of the embodiment depicted in FIG. 4. FIG. 5 shows what FIG. 4 shows plus the front side of block/catch panel 16 which includes removable absorbent material pieces 24 inserted and secured within pocket 26 created by the front surface 28 of block/catch panel 16 and the back surface (not shown) of front partial panel piece 30. This way, cat spray which impacts block/catch panel 16 is blocked from going beyond the panel. Also, this way cat spray which impacts block/catch panel 16's front surface 28 above pocket 26 collects and drains down by gravity into pocket 26 and onto and into removable absorbent material pieces 24 within pocket 26. Therefore, not only is the cat spray blocked, it is also caught and collected in, and may be conveniently removed with, the removable absorbent material pieces 24 for disposal.

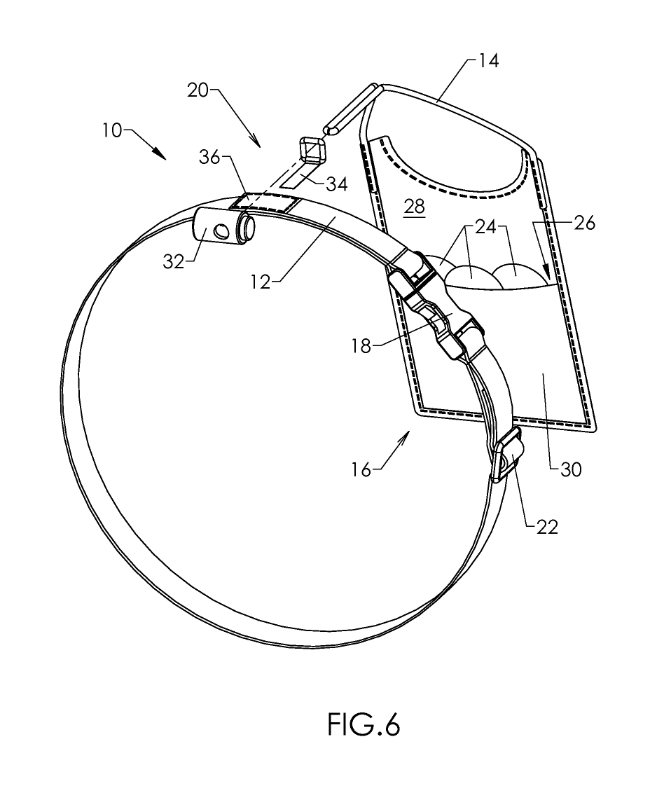

FIG. 6 is a front perspective exploded view of the embodiment depicted in FIGS. 1-5. This Figure shows that adjustable tail cord clamp 20 is an assembly of clamp barrel 32 and clamp connector 34. Connector 34 is attached both to the clamp barrel 32 by glue or weld, for example, and to waist belt 12 via first overlay piece 36 which creates a snug orifice for attaching connector 34, also by glue or weld, for example.

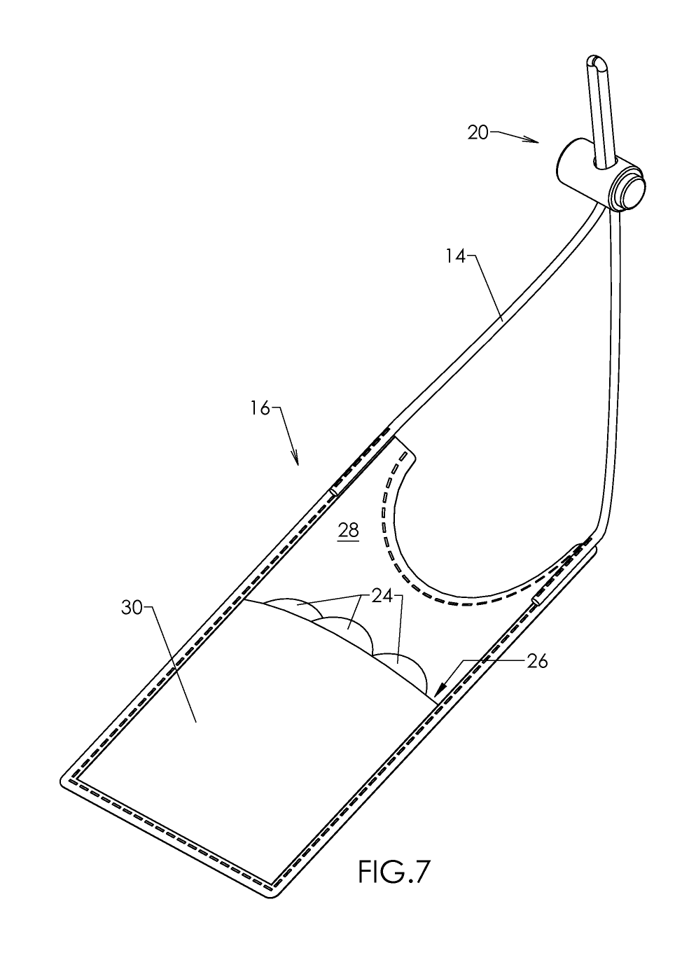

FIG. 7 is a front perspective detail view of the block/catch panel 16 without the waist belt 12, but with the tail cord 14.

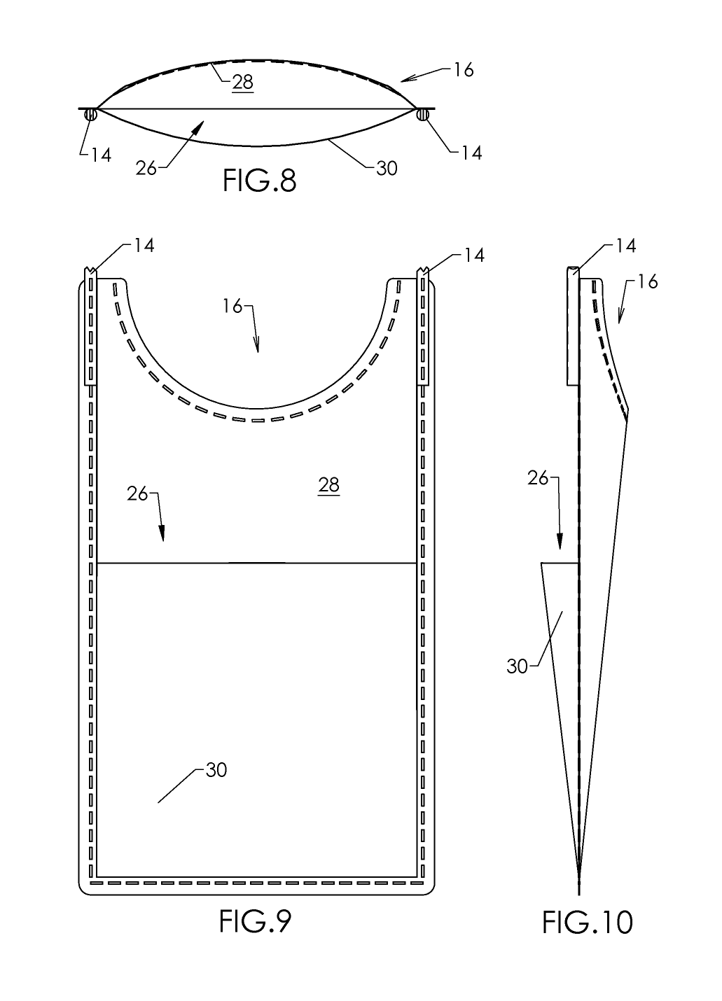

FIGS. 8-10 are detail views of the block/catch panel 16 like in FIG. 7, but with only two fragments of tail cord 14 shown. This Figure shows that the breadth, depth and volume of pocket 26 may be substantial, depending upon the shape of the components used to make block/catch panel 16. In this embodiment of block/catch panel 16, the tail cord 14 does not extend all the way around the sides and bottom periphery of the panel.

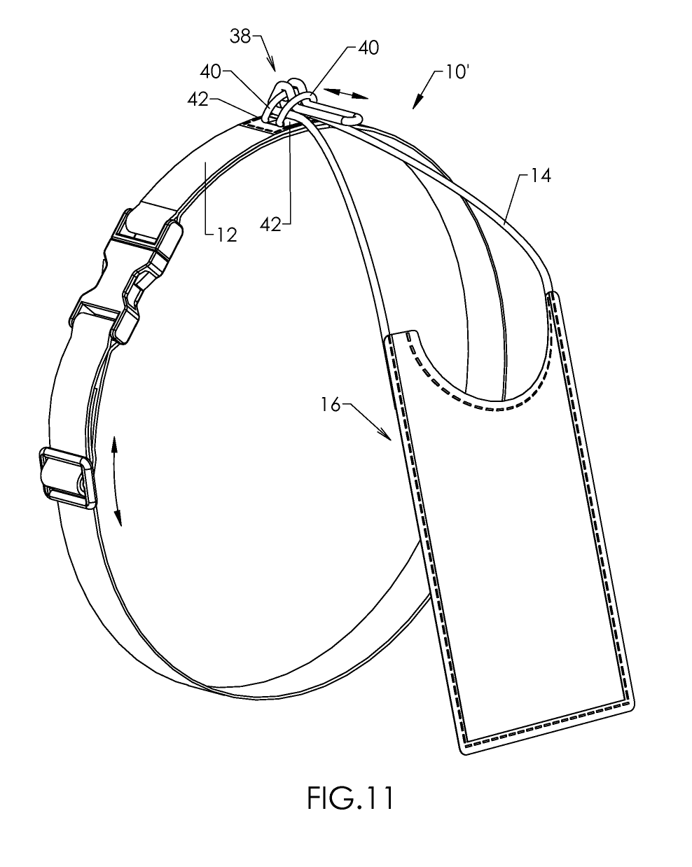

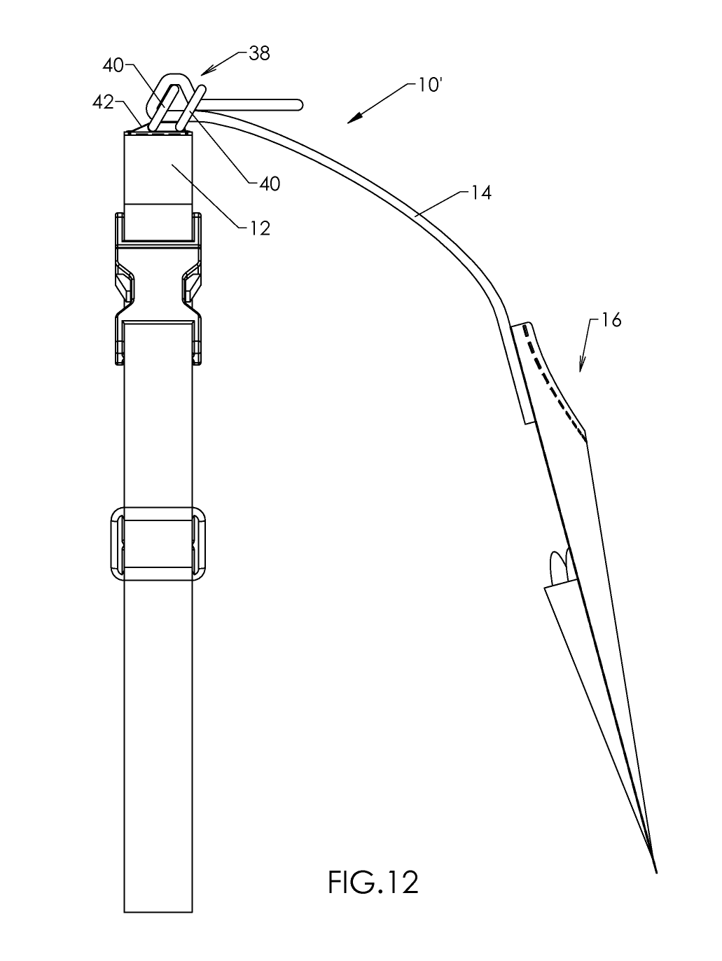

FIGS. 11 and 12 depict a rear perspective view and a side view, respectively, of an alternate embodiment 10′ of the present blocker and catcher with a different double ring connector 38 for attaching and adjusting the tail cord 14 to waist belt 12. Double ring connector 38 has two, spaced-apart parallel rings 40 imbedded within and extending radially outwardly from second overlay piece 42 on waist belt 12. This way, the folded-over portion of tail cord 14 may be threaded first through both rings 40, then over one ring and under the next as shown in the FIGS. 11 and 12 to adjustably and securely attach tail cord 14 to waist belt 12.

Although this disclosed technology has been described above with reference to particular means, materials and embodiments, it is to be understood that the disclosed technology is not limited to these disclosed particulars, but extends instead to all equivalents within the broad scope of the following Claims.

I claim:

1. A cat spray blocker and catcher, comprising:
a generally flat panel, the panel being connected to and supported by a tail cord, which tail cord is adapted to pass around or by both sides of a cat's tail;
said cord being connected to and supported by a waist strap, which waist strap is adapted to pass around a cat's waist or chest or neck, so that the generally flat panel is positioned beneath the cat's tail, and behind the cat's butt to block and catch cat spray.

2. The cat spray blocker and catcher of claim 1, wherein the generally flat panel is of, at least partly, a waterproof material.

3. The cat spray blocker and catcher of claim 1, wherein the generally flat panel is adapted to be, at least partly, absorbent.

4. The cat spray blocker and catcher of claim 1, wherein the generally flat panel has a pocket near its bottom.

5. The cat spray blocker and catcher of claim 4, wherein there is an absorbent in the pocket.

6. The cat spray blocker and catcher of claim 5, wherein the absorbent is removable and disposable.

7. The cat spray blocker and catcher of claim 1 wherein the tail cord is adjustable.

8. The cat spray blocker and catcher of claim 1 wherein the waist strap is adjustable.
